(19) United States
(12) Patent Application Publication
(10) Pub. No.: US 2026/0222968 A1
(43) Pub. Date: Jul. 30, 2026

(54) METHOD AND APPARATUS FOR CAG CELL SELECTION IN WIRELESS COMMUNICATION SYSTEM

(71) Applicant: SAMSUNG ELECTRONICS CO., LTD., Suwon-si (KR)

(72) Inventors: Utsav SINHA, Bangalore (IN); Lalith KUMAR, Bangalore (IN); Danish Ehsan HASHMI, Bangalore (IN); Anurag MANDILWAR, Bangalore (IN); Vishal YADAV, Bangalore (IN)

(21) Appl. No.: 19/555,385

(22) Filed: Mar. 3, 2026

Related U.S. Application Data
(63) Continuation of application No. PCT/KR2024/014212, filed on Sep. 20, 2024.

(30) Foreign Application Priority Data
Sep. 25, 2023 (IN) 202341064364
Sep. 6, 2024 (IN) 202341064364

(51) Int. Cl. H04W 48/02; H04W 48/20

(52) U.S. Cl. CPC H04W 48/02; H04W 48/20

(57) ABSTRACT

A method of a mobile station (MS) for performing closed access group (CAG) selection is disclosed. The method may comprise camping on a cell of a first public land mobile network (PLMN); and performing PLMN selection, cell selection or cell re-selection based on a current time, and a time validity information corresponding to each CAG-identifier(ID) for a second PLMN, based on the MS being in a limited service state in the first PLMN, and being in an automatic PLMN selection mode.

### CROSS-REFERENCE TO RELATED APPLICATIONS

This application is a continuation of International Application No. PCT/KR2024/014212 designating the United States, filed on Sep. 20, 2024, in the Korean Intellectual Property Receiving Office and claiming priority to Indian Provisional Patent Application No. 202341064364, filed on Sep. 25, 2023, and Indian Complete Patent Application No. 202341064364, filed on Sep. 6, 2024, in the Indian Patent Office, the disclosures of each of which are incorporated by reference herein in their entireties.

### BACKGROUND

### Field

The disclosure relates to Closed Access Groups (CAGs) in Public Network Integrated Non-Public Networks (NPNs) (PNI-NPNs), and for example, to methods and systems for performing CAG selection based on the time validity change of a CAG in PNI-NPNs.

### Description of Related Art

Public Network Integrated Non-Public Networks (PNI-NPNs) are NPNs provided through Public Land Mobile Networks (PLMNs), either using dedicated Data Network Names (DNNs) or specific Network Slice instances. As detailed in TS 23.501, network slicing allows different functionalities within the PLMN. To access a PNI-NPN, the User Equipment (UE)/Mobile Station (MS) must have a subscription to the associated PLMN. However, since network slicing alone cannot prevent/block UEs from accessing unauthorized areas, Closed Access Groups (CAGs) can optionally be used to enforce access control within PNI-NPNs.

A CAG is a specific group of subscribers who are authorized to access certain cells within a network. In PNI-NPNs, the CAG ensures that only permitted MSs can connect to these designated cells, preventing/suppressing unauthorized MSs from automatically selecting or accessing these restricted areas/cells of the network.

The MS may support CAG. The MS may support enhanced CAG information. If the MS supports CAGs, it may also support enhanced CAG information. In such cases, supporting enhanced CAG information may refer to the MS must support CAG. When the MS supports CAG, the network can provide it with a “CAG information list,” which includes one or more entries detailing specific CAGs. This list helps the MS to identify and connect to authorized CAGs within the network. If the MS supports CAG, the MS can be provisioned by the network with a “CAG information list”, comprising of zero or more entries, each containing:
a PLMN ID;
an “Allowed CAG list”. The “Allowed CAG list” contains zero or more CAGIDs. If the UE supports enhanced CAG information, each CAG-ID in the “Allowed CAG list” can be associated with time validity information; and
an optional “indication that the MS is only allowed to access 5GS via CAG cells”. CAG-ID authorized based on “Allowed CAG list”:

A CAG-ID in an “Allowed CAG list”, without a time validity information, or with a time validity information matching the UE's current time.

For Automatic PLMN selection, if the MS supports CAG and
is provisioned with a non-empty “CAG information list”, the MS may consider a PLMN indicated by an NG-RAN cell only if:

The cell functions as a CAG cell and broadcasts a CAG Identifier (CAG-ID) associated with a specific PLMN. This setup ensures that an entry corresponding to the PLMN ID is present in the “CAG information list,” and the CAG-ID is authorized according to the “Allowed CAG list” within that entry. The CAG cells operate within a mobile network, which can be identified by a unique CAG-ID. The identifier is linked to a particular network (PLMN), and for the cell to be valid and used by the mobile device, there must be a corresponding entry in the “CAG information list” for that network. Additionally, the CAG-ID must be on the “Allowed CAG list” for that entry, meaning it is authorized for use. The process ensures that only permitted CAG cells are selected or used by the mobile device within the network.
the cell is not a CAG cell and:
there is no entry with the PLMN ID of the PLMN in the “CAG information list”; or
there exists an entry with the PLMN ID of the PLMN in the “CAG information list” but the “indication that the MS is only allowed to access GS via CAG cells” is not included in the entry; or
is provisioned with an empty “CAG information list” or is not provisioned with a “CAG information list”, the MS may consider a PLMN indicated by an NG-RAN cell only if the cell is not a CAG cell.

There are various scenarios where a MS cannot obtain normal service from a PLMN. In an example, for an MS that supports Closed Access Groups (CAG), these scenarios might arise during the automatic PLMN selection process. In such cases, the MS may encounter issues like being unable to connect to a PLMN due to restrictions associated with the CAG or because the time validity of the CAG information does not match the MS's current time. These situations necessitate the MS to initiate specific actions, such as attempting to select a different PLMN or re-evaluating available cells, to regain service. For an MS supporting CAG these can include the following cases, for automatic PLMN selection:
Scenario 1: The MS that supports CAGs is currently camped on a CAG cell within a specific Public Land Mobile Network (PLMN). In this scenario, the CAG-ID associated with the CAG cell was not manually selected by the user. Furthermore, none of the CAG-IDs of the camped CAG cell are authorized according to the “Allowed CAG list” that is associated with the PLMN in the “CAG information list.” The MS is connected to a CAG cell that it did not actively choose, and the connection does not comply with the predefined CAGs authorized for that particular PLMN. In the example, the MS is camped in PLMN-1 CAG cell, broadcasting CAGID. The current time in the UE is 2 pm. The “Allowed CAG list” corresponding to PLMN-1 in the “CAG information list” include:
CAG-ID 1, time validity 3 pm to 4 pm.
CAG-ID 2, time validity 1 pm to 1:30 pm.

The MS will be in 5GMM sublayer state (for example in 5GMMREGISTERED.LIMITED-SERVICE or 5GMM-DEREGISTERED.LIMITEDSERVICE); in this case as time validity of CAG-ID does not match the MS's current time.

Scenario 2: When a MS that supports CAG is camped on a non-CAG cell within a PLMN, and the PLMN ID of this non-CAG cell, which lacks a CAG-ID, was not manually selected by the user, the device faces certain restrictions. Specifically, if the MS is configured with an indication that the MS is only permitted to access the 5G System (5GS) through CAG cells for that particular PLMN in the “CAG information list,” the MS will be limited in its network access options. This configuration prevents/blocks the MS from accessing the 5GS via non-CAG cells, ensuring that the device only connects through designated CAG cells within the specified PLMN.

In an example scenario, where the MS is camped on a non-CAG cell within PLMN-1, the “CAG information list” for PLMN-1 indicates that the MS is permitted to access the 5G system (5GS) exclusively through CAG cells. As a result, the MS will be in a 5GMM (5 G Mobility Management) sublayer state (such as, but not limited to, 5GMM-REGISTERED. LIMITED-SERVICE or 5GMM-DEREGISTERED.LIMITED-SERVICE). This may refer, for example, to while the MS is registered with the network, its service is restricted, limiting access to the network's services unless the MS connects to a CAG cell.

Scenario 3: When a MS that supports CAGs is either camped in a CAG or non-CAG cell, the MS may enter a 5G Mobility Management (5GMM) sublayer state (such as, but not limited to, 5GMM-REGISTERED.LIMITED-SERVICE or 5GMM-DEREGISTERED.LIMITED-SERVICE). This state can be triggered by various reasons, including but not limited to, the scenarios listed in bullets 1 to 3. For example, the MS might enter this state after receiving a Non-Access Stratum (NAS) message. In this situation, the MS is unable to locate a CAG cell that broadcasts an authorized CAG ID based on the “Allowed CAG list” in the “CAG information list.

In an example, consider that the MS is camped in 5GMM sublayer state (for example, in 5GMM-REGISTERED. LIMITED-SERVICE or 5GMMDEREGISTERED. LIMITED-SERVICE), camped in PLMN-1. Consider that the “CAG information list” has entry for PLMN-1, PLMN-2 etc., but the CAG-IDs in the “Allowed CAG list” for none of the entries of the “CAG information list” are currently authorized, based on the time validity information; e.g., say the current time in the UE is 2 pm, but the CAG information list says:
Entry 1: PLMN-1: a. CAG-ID 1, time validity 3 pm to 4 pm.
Entry 2: PLMN-2, a. CAG-ID 2, time validity 6 pm to 7 pm.

The MS will be in 5GMM sublayer state (for example, in 5GMMREGISTERED.LIMITED-SERVICE or 5GMM-DEREGISTERED.LIMITEDSERVICE) in the above case, as there are no CAGs available which are authorized by the “Allowed CAG list”.

FIG. 1 is a signal flow diagram illustrating an example scenario (1000), wherein the MS is in a 5GMM sublayer state (for example, in 5GMM-REGISTERED. LIMITED-SERVICE or 5GMM-DEREGISTERED.LIMITED-SERVICE), as there is no other cell available in the area which broadcasts a CAG-ID that is authorized based on “Allowed CAG list” which is received from the access and mobility management function (AMF) (100) (101). Consider that the CAG information list received from the NW contains the following entries:
Entry for PLMN-1:
CAG-ID 1, time validity 12 pm to 1 pm.
CAG-ID 2, time validity 1 pm to 1:30 pm.
CAG-ID 3, time validity 3 pm to 4:30 pm.

Consider that the MS is camped in PLMN-1 & CAG-ID 1 & current time in the MS/UE is 2 pm (102). There is no other cell available in the area which broadcasts a CAG-ID that is authorized based on the “Allowed CAG list” (103). Hence, the MS is in a 5GMM sublayer state (104) (for example, in 5GMM-REGISTERED.LIMITEDSERVICE or 5GMM-DEREGISTERED.LIMITED-SERVICE). The MS is in an area where no other cell is available that broadcasts an authorized CAG-ID according to the “Allowed CAG list.” As a result, the MS remains in a limited service state within the 5G Mobility Management (5GMM) sublayer (such as, but not limited to, being in the 5GMM-REGISTERED.LIMITED-SERVICE or 5GMM-DEREGISTERED.LIMITED-SERVICE state). The MS has restricted access to network services due to the unavailability of authorized cells broadcasting a suitable CAG-ID.

FIG. 2 is a signal flow diagram illustrating an example second scenario (2000), wherein the MS is in a 5GMM sublayer state (for example, in 5GMM-REGISTERED.LIMITED-SERVICE or 5GMM-DEREGISTERED.LIMITED-SERVICE), as there is no other cell available in the area which broadcasts a CAG-ID that is authorized based on “Allowed CAG list” which is received from the AMF (100) (201). When the MS is in a 5G Mobility Management (5GMM) sublayer state (such as, but not limited to, 5GMM-REGISTERED.LIMITED-SERVICE or 5GMM-DEREGISTERED.LIMITED-SERVICE), the MS is in a restricted service state with limited network access. In this situation, the MS is unable to find any cell in the area that broadcasts a CAG-ID that matches an entry in its “Allowed CAG list.” This may refer, for example, to the MS being unable to connect to a network that it is authorized to access, leaving it in a limited service state without any suitable cells available for full network connectivity. Consider that the CAG information list has been received from NW contains the following entries:
Entry for PLMN-1:
CAG-ID 1, time validity 12 pm to 1 pm.
CAG-ID 2, time validity 1 pm to 1:30 pm.
CAG-ID 3, time validity 3 pm to 4:30 pm.

Consider that the UE is configured with an “indication that the MS is only allowed to access 5GS via CAG cells” for PLMN-1 in the “CAG information list”. Consider that the MS is camped in PLMN-1, a non-CAG cell, and the current time in UE is 2 PM (202). Further, there is no other cell available in the area which broadcasts an authorized CAG-ID based on the “Allowed CAG list” (203). Hence, the MS is in a 5GMM sublayer state (204) (for example, in 5GMMREGISTERED.LIMITED-SERVICE or 5GMM-DEREGISTERED.LIMITEDSERVICE).

Hence, there is a need in the art to address the above mentioned drawback(s), among others.

### SUMMARY

Embodiments of the disclosure provide methods and systems for performing CAG selection on time validity change of a CAG, wherein a MS performs PLMN selection or cell selection or re-selection, and finds a cell broadcasting CAG-ID to regain full service.

Embodiments of the disclosure provide methods and systems for performing CAG selection on time validity change of a CAG, wherein a MS may perform PLMN selection, or cell selection or re-selection, if the time validity information of a CAG-ID in the “Allowed CAG list” corresponding to the current camped PLMN in the “CAG information list” starts matching the MS's current time.

Embodiments of the disclosure provide methods and systems for performing CAG selection on time validity change of a CAG, wherein the MS may perform PLMN selection (as per subclause 4.9.3.1.1 of 3GPP TS 23.122) or cell selection or re-selection, if the time validity information of a CAG-ID in the “Allowed CAG list” corresponding to a PLMN other than the current camped PLMN in the “CAG information list” starts matching the MS's current time,.

These and other aspects of the disclosure will be better appreciated and understood when considered in conjunction with the following description and the accompanying drawings. It should be understood, however, that the following descriptions, while indicating various example embodiments and numerous specific examples thereof, are given by way of illustration and not of limitation. Many changes and modifications may be made within the scope of the disclosure without departing from the spirit thereof, and the disclosure is understood to include all such modifications.

According to an example embodiment of the present disclosure, a method of a mobile station (MS) for performing closed access group (CAG) selection in a wireless communication system is disclosed. The method may comprise: camping on a cell of a first public land mobile network (PLMN); and performing PLMN selection, cell section or cell re-selection based on a current time, and a time validity information corresponding to each CAG-identifier(ID) for a second PLMN, based on the MS being in a limited service state in the first PLMN, and being in an automatic PLMN selection mode.

The MS may be in the limited service state as: the MS is camped in a non-CAG cell belonging to the first PLMN and the MS is configured with indication that the MS is only allowed to access 5GS via CAG cells for the first PLMN in a CAG information list; or the MS is camped in a CAG cell, but CAG-IDs of the CAG cell are not currently authorized based on an Allowed CAG list associated with the first PLMN in the CAG information list, wherein at least one CAG-ID changes from not authorized to authorized based on the “Allowed CAG list” associated with the second PLMN, due to a change in time of the MS.

Performing the PLMN selection may comprise: finding a CAG-ID which is authorized based on the Allowed CAG list associated with the second PLMN wherein the second PLMN is associated with the CAG information list stored in the MS, wherein the first PLMN is different from the second PLMN.

Performing the cell selection or the cell re-selection may comprise: selecting a CAG cell for which at least one CAG-ID changes from not authorized to authorized based on the Allowed CAG list associated with the first PLMN wherein the first PLMN is associated with the CAG information list stored in the CAG information list of the MS, wherein the first PLMN is the same as the second PLMN.

The time validity information of one or more CAG-IDs may change from not authorized to authorized based on the Allowed CAG list associated with the second PLMN in the CAG information list stored in the MS.

The MS may not have an emergency Packet Data Unit (PDU) session

The method may further comprise: not performing the PLMN selection, the cell selection or the cell re-selection based on the MS having a PDU session for emergency services; and performing the PLMN selection, the cell selection or the cell re-selection, based on successfully releasing the emergency PDU session, wherein the time validity information of one or more CAG-IDs are authorized based on Allowed CAG list.

According to an example embodiment of the present disclosure, a mobile station (MS) for performing closed access group (CAG) selection in a wireless communication system is disclosed. The MS may comprise: memory storing instructions; and at least one processor, comprising processing circuitry. The instructions, when executed by the at least one processor, individually and/or collectively, may cause the MS to: camp on a cell of a first public land mobile network (PLMN); and perform PLMN selection, cell section or cell re-selection based on a current time, and a time validity information corresponding to each CAG-ID for a second PLMN, based on the MS being in a limited service state in current PLMN, and being in an automatic PLMN selection mode.

According to an example embodiment of the present disclosure, a non-transitory computer-readable storage medium storing instructions is disclosed. The instructions, when executed by at least one processor, comprising processing circuitry, of a mobile station (MS), individually and/or collectively, may cause the MS to perform operations comprising: camping on a cell of a first public land mobile network (PLMN; and performing PLMN selection, cell section or cell re-selection based on a current time, and a time validity information corresponding to each CAG-identifier(ID) for a second PLMN, based on the MS being in a limited service state in the first PLMN, and being in an automatic PLMN selection mode.

Accordingly, various example embodiments herein provide a method for performing Closed Access Group (CAG) selection performing Public Land Mobile Network (PLMN) selection based on a current time of the MS, and a time validity information of a CAG-ID corresponding to a first PLMN, wherein the MS is in a limited service state, and is in an automatic PLMN selection mode.

Accordingly, the disclosure may provide a method for performing Closed Access Group (CAG) selection performing Cell selection or re-selection based on the current time of the MS, and a time validity information of a CAG-ID corresponding to a current PLMN, wherein the MS is in a limited service state, and is in an automatic PLMN selection mode.

Accordingly, the disclosure may provide a method for finding a CAG-ID which is authorized based on the “Allowed CAG list” associated with the PLMN wherein the PLMN may be associated with the “CAG information list” stored in the MS.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a signal flow diagram illustrating an example scenario, wherein the MS is in a 5GMM sublayer state (for example, in 5GMM-REGISTERED.LIMITED-SERVICE or 5GMM-DEREGISTERED.LIMITED-SERVICE) while camped in a CAG cell, as there is no other cell available in the area which broadcasts a CAG-ID that is authorized based on “Allowed CAG list”, according to the prior art;

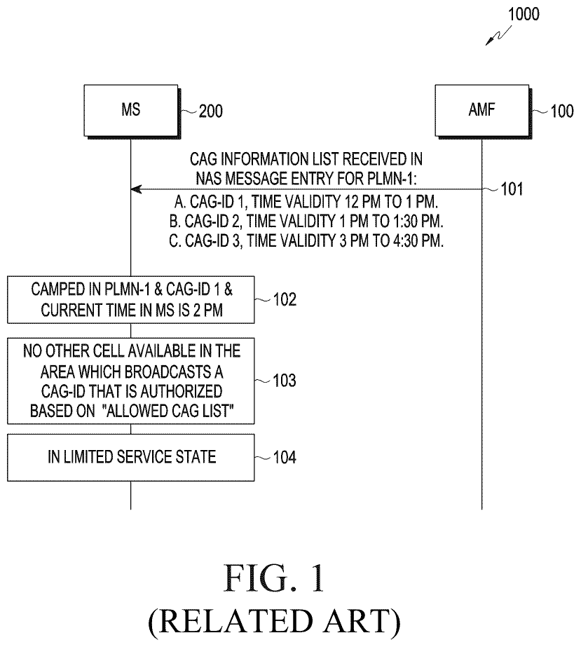

FIG. 2 is a signal flow diagram illustrating an example scenario, wherein the MS is in a limited service 5GMM sublayer state (for example, in 5GMM-REGISTERED.LIMITED SERVICE or 5GMM-DEREGISTERED.LIMITED-SERVICE) while camped in a non-CAG cell (as there is no other cell available in the area which broadcasts a CAG-ID that is authorized based on “Allowed CAG list”), according to various embodiments;

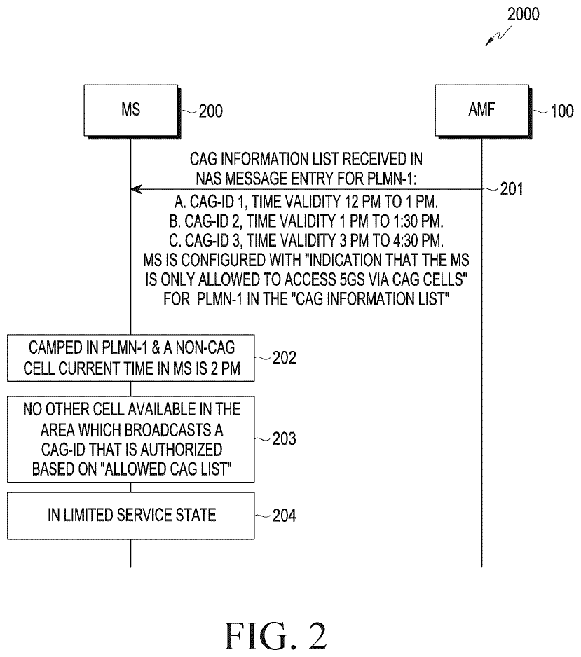

FIG. 3 is a signal flow diagram illustrating example scenario, where the MS is camped in a CAG cell & in 5GMM sublayer state (for example, in 5GMMREGISTERED.LIMITED-SERVICE or 5GMM-DEREGISTERED.LIMITEDSERVICE) and time validity information of a CAG-ID in the “Allowed CAG list” corresponding to the current camped PLMN or any other PLMN having an entry in the “CAG information list” starts matching the MS's current time, & the MS performs PLMN selection, cell selection or re-selection to regain full service, according to various embodiments;

FIG. 4 is a signal flow diagram illustrating an example scenario, where the MS is camped in a non-CAG cell & time validity information of a CAG-ID in the “Allowed CAG list” corresponding to a current camped PLMN or any other PLMN having an entry in the “CAG information list” starts matching the MS's current time, the MS may perform PLMN selection or cell selection or re-selection to regain full service, according to various embodiments; and

FIG. 5 is a block diagram illustrating an example configuration of the MS, according to various embodiments.

### DETAILED DESCRIPTION

Various example embodiments herein and various features and advantageous details thereof are explained more fully with reference to the non-limiting embodiments that are illustrated in the accompanying drawings and described herein. Descriptions of well-known components and processing techniques may be omitted so as to not unnecessarily obscure the embodiments herein. The examples used herein are intended merely to facilitate an understanding of ways in which the disclosure herein may be practiced. Accordingly, the examples should not be construed as limiting the scope of the disclosure.

For the purposes of interpreting this disclosure, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to refer, for example, to “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be understood as being preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. The blocks of various embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding various aspects of the disclosure. In terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. In terms of the system, one or more components/modules which comprise the system may have been represented in the drawings by conventional symbols, and the drawings may show various details that are pertinent to understanding the present disclosure so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The various example embodiments herein disclose methods and systems for performing Closed Access Group (CAG) selection on time validity change of a CAG. The method includes performing Public Land Mobile Network (PLMN) selection by a Mobile station (MS) based on a current time of the MS, and a time validity information of a Closed Access Group ID (CAG-ID) corresponding to a first PLMN, wherein the MS is in a limited service state in current PLMN, and is in an automatic PLMN selection mode.

The MS enters a limited service state, when the MS is connected to a non-CAG cell within a PLMN, but is only permitted to access 5G services through CAG cells, as specified in the “CAG information list”. Alternatively, the MS may be camped in a CAG cell, but the CAG-IDs of the cell are not authorized according to the “Allowed CAG list” for the current PLMN. A change in the MS's timing can cause at least one CAG-ID from the “Allowed CAG list” to be authorized for a different PLMN, distinct from the current one.

In an embodiment herein, the method can involve performing PLMN selection by a MS. For example, the MS may identify a CAG-ID that is authorized based on an “Allowed CAG list” linked to a first PLMN. This first PLMN is associated with a CAG information list stored within the MS, ensuring that the MS connects to an authorized and valid CAG within the network.

In an embodiment herein, the time validity information of one or more CAG-IDs can change from not authorized to authorized based on the “Allowed CAG list” associated with the first PLMN in a CAG information list stored in the MS.

In an embodiment herein, the method may involve the MS handling PLMN selection in the context of emergency services. For example, the MS does not perform PLMN selection, if the MS has an active PDU session for emergency services. Once the emergency session is successfully released, the MS then performs PLMN selection. During this process, the validity of the time-sensitive information for one or more CAG-IDs remains authorized based on the “Allowed CAG list.” This ensures that the MS can efficiently manage network selection while maintaining access to authorized CAGs.

In an embodiment herein, the MS may include a processor (e.g., at least one processor comprising processing circuitry) and memory, where the processor is configured to perform PLMN selection. This selection is based on the current time of the MS and the time validity information of the CAG-ID corresponding to a first PLMN. The MS operates in a limited service state and is in automatic PLMN selection mode, ensuring that the MS connects to the most appropriate network based on time-sensitive criteria, even when service is restricted.

In an embodiment herein, the MS enters a limited service state when it is camped on a non-CAG cell within a PLMN, but is configured to only access 5G services via CAG cells in that PLMN's CAG information list. The MS can be camped on a CAG cell whose CAG-IDs are not currently authorized according to the “Allowed CAG list” of the current PLMN. If a CAG-ID becomes authorized due to a time-based change and the CAG-ID is associated with a different PLMN from the current one, the MS remains in a limited service state.

In an embodiment herein, the MS may include a processor, wherein the processor is configured to perform PLMN selection by identifying a CAG-ID that is authorized according to the “Allowed CAG list” associated with the first PLMN. This first PLMN can be linked to the CAG information list stored in the MS, enabling the device to connect to a network that it is permitted to access based on one or more pre-stored authorization criteria. This ensures that the MS selects a PLMN that aligns with the authorized network access restrictions.

In an embodiment herein, the time validity information in a MS changes from “not authorized” to “authorized” when the “Allowed CAG list” associated with the first PLMN in the CAG information list stored in the MS permits access. The MS is now authorized to connect to the network based on the updated CAG list for the specified PLMN.

In an embodiment herein, the method for CAG selection can involve performing cell selection or re-selection by the MS based on the current time and the time validity information of a CAG-ID associated with the current PLMN when it is in a limited service state and automatic PLMN selection mode. This approach ensures that the MS connects to the most appropriate network based on the validity of the CAG-ID, optimizing network access and connectivity for the user.

In an embodiment herein, consider that the MS is in the limited service state as the MS can be camped in a non-CAG cell belonging to a PLMN and the MS can be configured with an indication that the MS is only allowed to access 5GS via CAG cells“ for that PLMN in the CAG information list; or the MS is camped in a CAG cell, but CAG-IDs of the CAG cell are not currently authorized based on an ”Allowed CAG list“ associated with the current PLMN in the CAG information list, wherein at least one CAG-ID becomes authorized based on the “Allowed CAG list” associated with the current PLMN, due to a change in the time of the MS.

In an embodiment herein, the method may involve finding a CAG-ID by the MS which is authorized based on the “Allowed CAG list” associated with the current PLMN wherein the current PLMN is associated with the CAG information list stored in the “CAG information list” of the MS.

In an embodiment herein, the time validity information of one or more CAG-IDs can be changed from ‘not authorized’ to ‘authorized’, based on the “Allowed CAG list” associated with the current PLMN in a “CAG information list” stored in the MS.

In an embodiment herein, the MS may not perform cell selection or re-selection if the MS has an active PDU session for emergency services. The MS performs cell selection or re-selection, only after successfully releasing the emergency PDU session, wherein the time validity information of one or more CAG-IDs are still authorized based on the “Allowed CAG list”.

In an example embodiment herein, the MS comprises, at least one processor comprising processing circuitry; and a memory, wherein at least one processor is coupled with the memory. At least one processor, individually and/or collectively, may be configured to: perform cell selection or re-selection based on a current time of the MS, and a time validity information of a CAG-ID corresponding to a current PLMN, wherein the MS is in a limited service state, and is in an automatic PLMN selection mode. In an example embodiment herein, the MS can be in a limited service state, when the MS is located in a non-CAG (Closed Access Group) cell of a PLMN (Public Land Mobile Network) and is restricted to accessing the 5G network only through CAG cells listed in the CAG information. In an embodiment herein, the MS can be in a limited service state, when the MS is in a CAG cell, but the CAG-IDs of that cell are not currently authorized by the “Allowed CAG list” for the current PLMN. The authorization may change over time, causing at least one CAG-ID to eventually be recognized as permitted by the updated “Allowed CAG list.

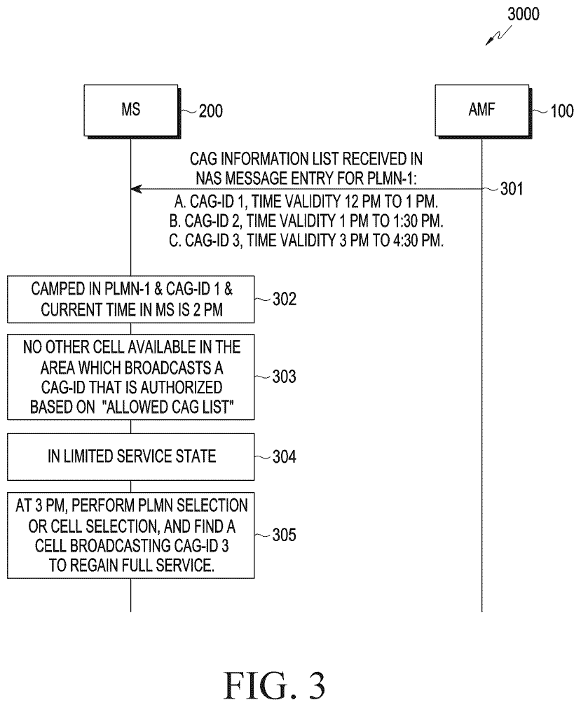

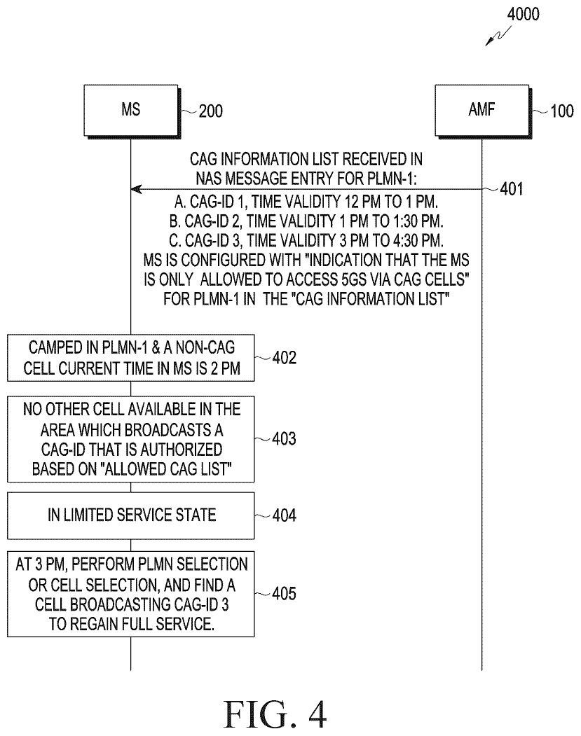

Referring now to the drawings, and more particularly to FIGS. 3 and 4, where similar reference characters denote corresponding features consistently throughout the figures, there are various example embodiments.

The following abbreviations may be used and referred to herein:
UE: User equipment
MS: Mobile Station
PNI NPN: Public Network Integrated non-Public Network
CAG: Closed Access Group
PLMN: Public Land Mobile Network
AMF: Access & Mobility Management Function
NG RAN: Next generation Radio Access Network
3GPP: Third Generation Partnership Project
4G-GUTI: 4G-Globally Unique Temporary Identifier
5G-BRG: 5G Broadband Residential Gateway
5GC: 5G Core
5GCN: 5G Core Network
5G-CRG: 5G Cable Residential Gateway
5G-GUTI: 5G-Globally Unique Temporary Identifier
5GMM: 5G Mobility Management
5G-RG: 5G Residential Gateway
5GS: 5G System
5GSM: 5GS Session Management
5G-S-TMSI: 5G S-Temporary Mobile Subscription Identifier
5G-TMSI: 5G Temporary Mobile Subscription Identifier
5QI: 5G QoS Identifier
ACS: Auto-Configuration Server
AKA: Authentication and Key Agreement
KID: AKMA Key Identifier
AKMA: Authentication and Key Management for Applications
AMBR: Aggregate Maximum Bit Rate
AMF: Access and Mobility Management Function
APN: Access Point Name
ARP: Allocation and Retention Policy
AS: Access Stratum
TID: AKMA Temporary Identifier
ATSSS: Access Traffic Steering, Switching and Splitting
AUSF: Authentication Server Function
CAG: Closed access group
CAG ID: Closed Access Group Identifier
CHAP: Challenge Handshake Authentication Protocol
CU: Centralized Unit
DC: Discontinuous Coverage
DisCo: Discontinuous Coverage
DL: Downlink
DND: Do not Disturb
DRX: Discontinuous Reception
DU: Distributed Unit
eDRX: Extended Discontinuous Reception
EHPLMN: Equivalent Home Public Land Mobile Network
EMM: EUTRA Mobility Management
eNB: Evolved Node-B
eNPN: Enhanced Non-Public Networks
EPC: Evolved Packet Core
EPLMN: Equivalent Public Land Mobile Network
EPS: Evolved Packet System
eSIM: embedded Subscriber Identity Module
E-UTRA: Evolved Universal Mobile Telecommunication Access
EUTRAN: Evolved Universal Mobile Telecommunication Access Network
FPLMN: Forbidden Public Land Mobile Network
FR: Frequency Range
GEO: Geostationary Orbit
GERAN: GSM Edge Radio Access Network
GERAN EC-GSM-IoT: GSM Edge Radio Access Network Extended Coverage-GSM-Internet of Things
gNB: Next generation Node-B
gNB-CU: Next generation Node-B Control Unit
gNB-DU: Next generation Node-B Distributive Unit
GPRS: General Packet Radio Service
GPS: Global Positioning System
GSM: Global System for Mobile Communication
HPLMN: Home Public Land Mobile Network
IAB: Integrated access and backhaul
IAB-UE: The part of the IAB node that supports the Uu interface towards the IABdonor or another parent IAB-node (and thus manages the backhaul connectivity with either PLMN or SNPN it is registered with) is referred to as an IAB-UE.
LADN: Local Area Data Network
LCS: Location services
LEO: Low Earth Orbit
MBSR: Mobile Base Station Relay
MCC: Mobile Country Code
MCS: Mission Critical Service
ME: Mobile Equipment
MEC: Multi-Access Edge Computing
MEO: Medium Earth Orbit
MICO: Mobile Initiated Communication Only
MINT: Minimization of service interruption
MME: Mobility Management Entity
MNC: Mobile Network Code
MPS: Multimedia Priority Service
MS: Mobile Station. The present disclosure makes no distinction between MS and UE.
NAS: Non-Access Stratum
NB-S1 Mode: Narrow Band with S1 Interface
NGAP: Next Generation Application Protocol
NG-RAN: Next Generation Radio Access Network
NPN: Non-Public Networks
NR: New Radio
NTN: Non Terrestrial Networks
NW: Network
OOS: Out of Service
OS Upgrade: Operating System Upgrade
PDN: Packet Data Network
PDU: Packet Data Unit
PLMN ID: Public Land Mobile Network Identity
PSM: Power Saving Mode
QoS: Quality Of Service
RAT: Radio Access Technology
RPLMN: Registered Public Land Mobile Network
RRC: Radio Resource Control
RU: Registration Update
SAT: Satellite
Satellite: An artificial body placed in orbit round the earth or moon or another planet in order to collect information or for communication.
Satellite Constellation: Group of satellites, placed in orbit round the earth or moon or another planet in order to collect information or for communication.
Service User: An individual who has received a priority level assignment from a regional/national authority (e.g., an agency authorized to issue priority assignments) and has a subscription to a mobile network operator
SIM: Subscriber Identity Module
SNPN: Standalone Non-Public Networks
SUCI: Subscription Concealed Identifier
SW: Software
TAC: Tracking Area Code
TAI: Tracking Area Identity
TAU: Tracking Area Update
TER: Terrestrial
TN: Terrestrial Networks
UCU: UE Configuration Update
UDM: Unified Data Management Function
UE: User Equipment
UL: Uplink
ULI: User Location Information
UPU: UE Parameters Update
USIM: Universal Subscriber Identification Module
Uu: The radio interface between the UE and the Node B
VMR: Vehicle Mounted Relay
VPLMN: Visited Public Land Mobile Network
WB-S1: Mode Wide Band with S1 Interface

Visited PLMN (VPLMN): This is a PLMN different from the HPLMN (if the EHPLMN list is not present or is empty) or different from an EHPLMN (if the EHPLMN list is present).

Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: PLMN(s) in the given area which is/are broadcasting capability to provide wireless communication services to the UE.

Camped on a cell: The MS (ME if there is no SIM) has completed the cell
selection/reselection process and has chosen a cell from which it plans to receive all available services. Note that the services may be limited, and that the PLMN or the SNPN may not be aware of the existence of the MS (ME) within the chosen cell.

EHPLMN: Any of the PLMN entries contained in the Equivalent HPLMN list.

Equivalent HPLMN list: To allow provision for multiple HPLMN codes, PLMN codes that are present within this list may replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list, then it may be treated as a Visited PLMN for PLMN selection purposes.

Home PLMN: This is a PLMN where the MCC and MNC of the PLMN identity match the MCC and MNC of the IMSI.

Registered PLMN (RPLMN): This is the PLMN on which certain LR (location registration which is also called as registration procedure) outcomes have occurred.

In a shared network, the RPLMN is the PLMN defined by the PLMN identity of the CN operator that has accepted the LR.

Registration: This is the process of camping on a cell of the PLMN or the SNPN and doing any necessary LRs.

UPLMN: PLMN/access technology combination in the “User Controlled PLMN Selector with Access Technology” data file in the SIM (in priority order).

OPLMN: PLMN/access technology combination in the “Operator Controlled

PLMN Selector with Access Technology” data file in the SIM (in priority order) or stored in the ME (in priority order).

The following is an example list of NAS messages (and not limited to): REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command; and UE PARAMETERS UPDATE command.

The term 5GMM sublayer states in the disclosure may include at least one of the below:
5GMM-NULL
5GMM-DEREGISTERED
5GMM-DEREGISTERED.NORMAL-SERVICE
5GMM-DEREGISTERED.LIMITED-SERVICE
5GMM-DEREGISTERED.ATTEMPTING-REGISTRATION
5GMM-DEREGISTERED.PLMN-SEARCH
5GMM-DEREGISTERED.NO-SUPI
5GMM-DEREGISTERED.NO-CELL-AVAILABLE
5GMM-DEREGISTERED.eCALL-INACTIVE
5GMM-DEREGISTERED.INITIAL-REGISTRATION-NEEDED
5GMM-REGISTERED-INITIATED
5GMM-REGISTERED
5GMM-REGISTERED.NORMAL-SERVICE
5GMM-REGISTERED.NON-ALLOWED-SERVICE
5GMM-REGISTERED.ATTEMPTING-REGISTRATION-UPDATE
5GMM-REGISTERED.LIMITED-SERVICE
5GMM-REGISTERED.PLMN-SEARCH
5GMM-REGISTERED.NO-CELL-AVAILABLE
5GMM-REGISTERED.UPDATE-NEEDED
5GMM-DEREGISTERED-INITIATED
5GMM-SERVICE-REQUEST-INITIATED

In this embodiment herein, the term EMM sublayer states are at least one of the following:
EMM-NULL
EMM-DEREGISTERED
EMM-DEREGISTERED.NORMAL-SERVICE,
EMM-DEREGISTERED.LIMITED-SERVICE
EMM-DEREGISTERED.ATTEMPTING-TO-ATTACH
EMM-DEREGISTERED.PLMN-SEARCH
EMM-DEREGISTERED.NO-IMSI
EMM-DEREGISTERED.ATTACH-NEEDED
EMM-DEREGISTERED.NO-CELL-AVAILABLE
EMM-DEREGISTERED.eCALL-INACTIVE
EMM-REGISTERED-INITIATED
EMM-REGISTERED
EMM-REGISTERED.NORMAL-SERVICE
EMM-REGISTERED.ATTEMPTING-TO-UPDATE
EMM-REGISTERED.LIMITED-SERVICE
EMM-REGISTERED.PLMN-SEARCH
EMM-REGISTERED.UPDATE-NEEDED
EMM-REGISTERED.NO-CELL-AVAILABLE
EMM-REGISTERED.ATTEMPTING-TO-UPDATE-MM
EMM-REGISTERED.IMSI-DETACH-INITIATED
EMM-DEREGISTERED-INITIATED
EMM-TRACKING-AREA-UPDATING-INITIATED
EMM-SERVICE-REQUEST-INITIATED
In automatic PLMN selection mode, if the MS supports CAG, and is a 5GMM sublayer state (for example, in 5GMM-REGISTERED.LIMITEDSERVICE or 5GMM-DEREGISTERED.LIMITED-SERVICE) & the MS does not have a PDU session for emergency services, if:
The time validity information of a CAG-ID in the “Allowed CAG list” corresponding to the current camped PLMN in the “CAG information list” starts matching the MS's current time, the MS may perform cell selection or re-selection or PLMN selection. Therefore, when the time validity information of a Closed Access Group (CAG) ID in the “Allowed CAG list,” corresponding to the currently camped Public Land Mobile Network (PLMN), matches the Mobile Station's (MS) current time, the MS initiates cell selection, re-selection, or PLMN selection. This ensures that the MS remains connected to an appropriate and authorized network based on updated time-sensitive information, thereby maintaining efficient and secure network access. or
The time validity information of a CAG-ID in the “Allowed CAG list” corresponding to a PLMN other than the current camped PLMN in the “CAG information list” starts matching the MS's current time, the MS may perform PLMN selection as per subclause 4.9.3.1.1 or cell selection or re-selection. Therefore, when the time validity information of a Closed Access Group Identifier (CAG-ID) in the “Allowed CAG list” for a Public Land Mobile Network (PLMN) other than the currently camped PLMN matches the mobile station's (MS) current time, the MS must initiate either PLMN selection according to subclause 4.9.3.1.1 or perform cell selection or re-selection. This ensures that the MS transitions to an appropriate network or cell based on the updated CAG-ID validity, maintaining optimal network connectivity; or
For example, while in 5GMM sublayer state (for example, in 5GMMREGISTERED.LIMITED-SERVICE or 5GMM-DEREGISTERED.LIMITED SERVICE), and time validity information of the broadcasted CAG-ID corresponding to a PLMN that has entry in the “CAG information list” becomes authorized by the “Allowed CAG list” corresponding to that PLMN, the MS may perform PLMN selection or cell selection or re-selection; e.g., the time validity information of the broadcasted CAG-ID corresponding to a PLMN that has entry in the “CAG information list” starts matching the MS's current time, the MS may perform PLMN selection or cell selection or cell-re-selection; or
If the MS has an established emergency PDU session, then the UE may attempt to perform the PLMN selection, cell selection or re-selection subsequently after the emergency PDU session is released.

FIG. 3 is a signal flow diagram illustrating an example scenario (3000), where the MS is camped in a CAG cell & in 5GMM sublayer state (for example, in 5GMM REGISTERED.LIMITED-SERVICE or 5GMM-DEREGISTERED.LIMITEDSERVICE) and time validity information of a CAG-ID in the “Allowed CAG list” corresponding to the current camped PLMN or any other PLMN having an entry in the “CAG information list” starts matching the MS's current time, & the MS performs PLMN selection, cell selection or re-selection to regain full service according to various embodiments. Consider that the CAG information list received from the NW (e.g. the AMF (100) (301) contains the following entries:
Entry for PLMN-1:
CAG-ID 1, time validity 12 PM to 1 PM.
CAG-ID 2, time validity 1 PM to 1:30 PM.
CAG-ID 3, time validity 3 PM to 4:30 PM.

Consider that the MS is camped in PLMN-1 & a CAG cell broadcasting CAG-ID 1 & the current time in the UE is 2 PM (302). Further, there is no other CAG cell available in the area which broadcasts a CAG-ID that is authorized based on “Allowed CAG list” (303). Consider that the MS in 5GMM sublayer state (304) (for example, in 5GMM-REGISTERED.LIMITED-SERVICE or 5GMMDEREGISTERED.LIMITED-SERVICE). In an example, at 3PM, the MS performs PLMN selection or cell selection or re-selection, and find a cell broadcasting CAG-ID 3 to regain full service (305). The various actions in method 3000 may be performed in the order presented, in a different order or simultaneously. In various embodiments, some actions listed in FIG. 3 may be omitted.

FIG. 4 is a signal flow diagram illustrating an example scenario (400), where the MS is camped in a non-CAG cell & time validity information of a CAG-ID in the “Allowed CAG list” corresponding to a current camped PLMN or any other PLMN having an entry in the “CAG information list” starts matching the MS's current time, the MS may perform PLMN selection or cell selection or re-selection to regain full service according to various embodiments. Consider that the MS supports CAG & the CAG information list received from the NW (e.g. the AMF (100) (401) contains the following entries:
Entry for PLMN-1:
CAG-ID 1, time validity 12 PM to 1 PM.
CAG-ID 2, time validity 1 PM to 1:30 PM.
CAG-ID 3, time validity 3 PM to 4:30 PM.

Consider that the MS is configured with an “indication that the MS is only allowed to access 5GS via CAG cells” for PLMN-1 in the “CAG information list”. Further, the MS is camped in PLMN-1 & a non-CAG cell, and current time in the MS is 2 PM (402). Further, no other cell is available in the area which broadcasts a CAGID that is authorized based on “Allowed CAG list” (403). If the MS is in a 5GMM sublayer state (404) (for example, in 5GMM-REGISTERED.LIMITED-SERVICE or 5GMMDEREGISTERED.LIMITED-SERVICE), in an example, at 3 PM, the MS can perform PLMN selection or cell selection or re-selection, and find a cell broadcasting CAG-ID 3 to regain full service (405). The various actions in method 4000 may be performed in the order presented, in a different order or simultaneously. In various embodiments, some actions listed in FIG. 4 may be omitted.

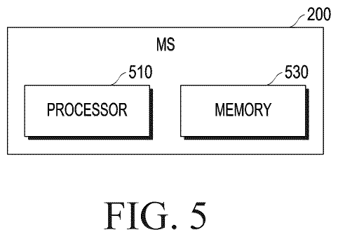

FIG. 5 is a block diagram illustrating an example configuration of the MS (200), according to various embodiments. The MS (200) comprises at least one processor (e.g., including processing circuitry) (510) and a memory (530) storing instructions.

The processor 510 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The instructions, when executed by at least one processor (510), cause the MS (200) to perform operations of the MS (200) described herein.

The MS is configured to perform PLMN selection, cell selection, or cell reselection based on a current time of the MS and a time validity information of a CAG-ID corresponding to a first PLMN, wherein the MS is in limited service state and is in an automatic PLMN selection mode.

In an embodiment, the MS is in limited service state as the MS is camped in a non-CAG cell belonging to a PLMN and the MS is configured with indication that the MS is only allowed to access 5GS via CAG cells for that PLMN in the CAG information list or the MS is camped in a CAG cell, but CAG-IDs of the CAG cell are not currently authorized based on an “Allowed CAG list” associated with a current PLMN, wherein at least one CAG-ID becomes authorized based on the “Allowed CAG list” associated with the first PLMN, due to a change in time, and the first PLMN is different from the current PLMN.

Various example embodiments disclosed herein can be implemented through at least one software program running on at least one hardware device and performing network management functions to control the network elements. The elements include blocks which can be at least one of a hardware device, or a combination of hardware device and software module.

Various example embodiments disclosed herein describe methods and systems for performing CAG selection on time validity change of a CAG. The method enables the MS to quickly recover from a limited service state, which occurs when the MS is camped on a cell in a particular PLMN where no CAG-ID is authorized in the MS's “Allowed CAG list.” By utilizing the time validity information of a CAG, the MS can promptly perform PLMN selection, cell selection, or cell re-selection when the time validity of any CAG changes. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method may be implemented through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

The foregoing description of the various example embodiments will reveal the general nature of the embodiments herein so one skilled in the art, by applying current knowledge, readily modify and/or adapt for various applications without departing from the generic concept, and, therefore, such adaptations and modifications should and are intended to be comprehended within the meaning and range of equivalents of the disclosure, including the appended claims and their equivalents. It will also be understood that the phraseology or terminology employed herein is for the purpose of description and not of limitation. Therefore, while the disclosure has been described in terms of various example embodiments, those skilled in the art will recognize that the embodiments and examples disclosed herein can be practised with modification within the scope of the disclosure as described herein. It will also be understood that any of the embodiment(s) described herein may be used in conjunction with any other embodiment(s) described herein.

What is claimed is:

1. A method of a mobile station (MS) for performing closed access group (CAG) selection in a wireless communication system, the method comprising:
camping on a cell of a first public land mobile network (PLMN); and
performing PLMN selection, cell section or cell re-selection based on a current time, and a time validity information corresponding to each CAG-identifier(ID) for a second PLMN, based on the MS being in a limited service state in the first PLMN, and being in an automatic PLMN selection mode.

2. The method of claim 1, wherein the MS is in the limited service state as:
the MS is camped in a non-CAG cell belonging to the first PLMN and the MS is configured with indication that the MS is allowed to access 5GS via CAG cells for the first PLMN in a CAG information list; or
the MS is camped in a CAG cell, and CAG-IDs of the CAG cell are not currently authorized based on an Allowed CAG list associated with the first PLMN in the CAG information list, wherein at least one CAG-ID changes from not authorized to authorized based on the “Allowed CAG list” associated with the second PLMN, due to a change in time of the MS.

3. The method of claim 2, wherein performing the PLMN selection comprises:
finding a CAG-ID which is authorized based on the Allowed CAG list associated with the second PLMN wherein the second PLMN is associated with the CAG information list stored in the MS,
wherein the first PLMN is different from the second PLMN.

4. The method of claim 2, wherein performing the cell selection or the cell re-selection comprises:
selecting a CAG cell for which at least one CAG-ID changes from not authorized to authorized based on the Allowed CAG list associated with the first PLMN wherein the first PLMN is associated with the CAG information list stored in the CAG information list of the MS,
wherein the first PLMN is the same as the second PLMN.

5. The method of claim 2, wherein the time validity information of one or more CAG-IDs change from not authorized to authorized based on the Allowed CAG list associated with the second PLMN in the CAG information list stored in the MS.

6. The method of claim 1, wherein the MS does not have an emergency Packet Data Unit (PDU) session.

7. The method of claim 1, further comprising:
not performing the PLMN selection, the cell selection or the cell re-selection based on the MS having a PDU session for emergency services; and
performing the PLMN selection, the cell selection or the cell re-selection, based on successfully releasing the emergency PDU session, wherein the time validity information of one or more CAG-IDs are authorized based on Allowed CAG list.

8. A mobile station (MS) for performing closed access group (CAG) selection in a wireless communication system, the MS comprising:
memory storing instructions; and
at least one processor, comprising processing circuitry, wherein the instructions, when executed by the at least one processor, individually and/or collectively, cause the MS to:
camp on a cell of a first public land mobile network (PLMN); and
perform PLMN selection, cell section or cell re-selection based on a current time, and a time validity information corresponding to each CAG-identifier(ID) for a second PLMN, based on the MS being in a limited service state in current PLMN, and being in an automatic PLMN selection mode.

9. The MS of claim 8, wherein the MS is in the limited service state as:
the MS is camped in a non-CAG cell belonging to the first PLMN and the MS is configured with an indication that the MS is allowed to access 5GS via CAG cells for the first PLMN in a CAG information list; or
the MS is camped in a CAG cell, and CAG-IDs of the CAG cell are not currently authorized based on an Allowed CAG list associated with the first PLMN, wherein at least one CAG-ID changes from not authorized to authorized based on the Allowed CAG list associated with the second PLMN, due to a change in time.

10. The MS of claim 9, wherein for performing the PLMN selection, the instructions, when executed by the at least one processor, individually and/or collectively, cause the MS to:
find a CAG-ID authorized based on the “Allowed CAG list” associated with the second PLMN wherein the second PLMN is associated with the CAG information list stored in the MS,
wherein the first PLMN is different from the second PLMN.

11. The MS of claim 9, wherein for performing the cell selection or the cell re-selection, the instructions, when executed by the at least one processor, individually and/or collectively, cause the MS to:
select a CAG cell for which at least one CAG-ID changes from not authorized to authorized based on the Allowed CAG list associated with the first PLMN wherein the first PLMN is associated with the CAG information list stored in the CAG information list of the MS,
wherein the first PLMN is the same as the second PLMN.

12. The MS of claim 9, wherein the time validity information changes from not authorized to authorized based on the “Allowed CAG list” associated with the second PLMN in a CAG information list stored in the MS.

13. The MS of claim 8, wherein the MS does not have an emergency Packet Data Unit (PDU) session.

14. The MS, of claim 8, wherein the instructions, when executed by the at least on processor, individually and/or collectively, cause the MS to:
not perform the PLMN selection, the cell selection or the cell re-selection based on the MS having a PDU session for emergency services; and
perform the PLMN selection, the cell selection or the cell re-selection based on successfully releasing the emergency PDU session, wherein the time validity information of one or more CAG-IDs are authorized based on the Allowed CAG list.

15. A non-transitory computer-readable storage medium storing instructions, which, when executed by at least one processor, comprising processing circuitry, individually and/or collectively, of a mobile station (MS), individually and/or collectively, cause the MS to:
camp on a cell of a first public land mobile network (PLMN); and
perform PLMN selection, cell section or cell re-selection based on a current time, and a time validity information corresponding to each CAG-identifier(ID) for a second PLMN, based on the MS being in a limited service state in current PLMN, and being in an automatic PLMN selection mode.

16. The non-transitory computer-readable storage medium storing of claim 15, wherein the MS is in the limited service state as:
the MS is camped in a non-CAG cell belonging to the first PLMN and the MS is configured with an indication that the MS is only allowed to access 5GS via CAG cells for the first PLMN in a CAG information list; or
the MS is camped in a CAG cell, and CAG-IDs of the CAG cell are not currently authorized based on an Allowed CAG list associated with the first PLMN, wherein at least one CAG-ID changes from not authorized to authorized based on the Allowed CAG list associated with the second PLMN, due to a change in time.

17. The non-transitory computer-readable storage medium storing of claim 16, wherein for performing the PLMN selection, the instructions, when executed by the at least one processor, individually and/or collectively, cause the MS to:
find a CAG-ID authorized based on the “Allowed CAG list” associated with the second PLMN wherein the second PLMN is associated with the CAG information list stored in the MS,
wherein the first PLMN is different from the second PLMN.

18. The non-transitory computer-readable storage medium storing of claim 16, wherein for performing the cell selection or the cell re-selection, the instructions, when executed by the at least one processor, individually and/or collectively, cause the MS to:
select a CAG cell for which at least one CAG-ID changes from not authorized to authorized based on the Allowed CAG list associated with the first PLMN wherein the first PLMN is associated with the CAG information list stored in the CAG information list of the MS,
wherein the first PLMN is the same as the second PLMN.

19. The non-transitory computer-readable storage medium storing of claim 16, wherein the time validity information changes from not authorized to authorized based on the “Allowed CAG list” associated with the second PLMN in a CAG information list stored in the MS.

20. The non-transitory computer-readable storage medium storing of claim 16, wherein the instructions, when executed by the at least one processor, individually and/or collectively, cause the MS to:
not perform the PLMN selection, the cell selection or the cell re-selection based on the MS having a PDU session for emergency services; and
perform the PLMN selection, the cell selection or the cell re-selection based on successfully releasing the emergency PDU session, wherein the time validity information of one or more CAG-IDs are authorized based on the Allowed CAG list.
